(19) United States
(12) Patent Application Publication
(10) Pub. No.: US 2023/0145608 A1
(43) Pub. Date: May 11, 2023

(54) IMMERSIVE LEARNING APPLICATION

(71) Applicant: IntelliMedia Networks, Inc., Leesburg, VA (US)

(72) Inventors: Darshan Sedani, Cerritos, CA (US); Teodros Gessesse, Leesburg, VA (US); Devang Ajmera, Gujarat (IN); Joy Shah, Gujarat (IN); Rajkumar Ramakrishnan, Gujarat (IN)

(73) Assignee: IntelliMedia Networks, Inc., Leesburg, VA (US)

(21) Appl. No.: 17/592,296

(22) Filed: Feb. 3, 2022

Related U.S. Application Data
(63) Continuation of application No. 17/523,504, filed on Nov. 10, 2021.

(51) Int. Cl. G09B 5/06

(52) U.S. Cl. CPC G09B 5/065

(57) ABSTRACT

An integrated cloud-based software system for learning, training, and educational built as a set of user-accessible modules, operating collectively as a highly configurable environment providing full immersion in a simulated or virtual environment, presenting learning materials and experiences. The software system provides a set of user-selectable combinations of immersive user experiences available through a wide range of available interactive display devices such as personal computers, mobile tablets, mobile phones, over-the-top TV systems, and virtual reality headset environments. The software system also enables combining of information sources in said interactive display platforms, including interactive courseware, videos, documents, and virtual environments by the student or as designed by a courseware designer or teacher, to match any individualized style of learning.

### CROSS-REFERENCE TO RELATED APPLICATIONS

This application is related to and claims priority to U.S. application entitled Learning Training Management System; patent application Ser. No. 17/523,504, filed Nov. 10, 2021, the entire disclosure of which is herein incorporated by reference as a part of this application.

### FIELD

This invention is in the field of the immersive learning by means of interaction among and between educational software systems, learning systems, courseware management, informational communications and visualization systems, and virtual reality presentation system software, students, teachers, and learning system administrators.

### DESCRIPTION OF RELATED ART

As the Internet has grown in speed and computing power, and with the rise of cloud-based data storage and software as a service, online education has become increasingly enabled. Many efforts at standardizing online education and providing tools to enable multiple kinds of course materials to be mixed together have arisen. A critical threshold has also been reached where networking bandwidth and data transfer speeds of massive amounts of data are now sufficient to allow blending of live data streams. These factors have served to open a wide range of opportunities for designing and serving so-called massive open online courses to students worldwide.

Another convergence of technology is also maturing: the widespread availability of multiple kinds of user devices such as laptop computers, mobile phones, mobile tablets of various kinds, next-generation television program management services (so-called over-the-top (“OTT”) services), and virtual reality devices and related services. These devices are becoming sufficiently commonplace that widespread familiarity with their use is an enabler for convergent inter-operation of such device to enhance information delivery and interactivity. Users of such devices now often possess sufficient skills to be able to operate multiple devices and coordinate information between them with ease.

Taken together, these factors provide opportunities for development of inter-operating education systems which take advantage of multiple information delivery modalities including plain text, interactive text, audio, video, collaborative workspaces, and various combinations of live interactions between students and teachers while sharing and even contributing to information flows displayed on multiple devices simultaneous.

Such new systems serve to enhance learning rates of student, collaboration rates among professionals, and may even serve to enhance the rate of new discoveries in science by scientific research communities. The Immersive Learning Application disclosed hereunder is one such integrative software system in this new genre.

### SUMMARY

According to an embodiment of the disclosure, an Immersive Learning Application (ILA) is provided. The ILA may be a cloud-based integrated software system providing a rich context for education of trainees, employees in enterprise organizations, students in institutional settings, as well as individual students, through the operation of courseware, testing, skills validation and certification, courseware management, and inter-personal interactions of students and teachers in various ways. The core concept is providing a learning environment which is immersive in the sense that the student can utilize every available communications and display technology to be fully immersed in a simulated or artificial environment. The student is able to tune this environment to his/her own optimum style of information absorption.

A method and system of providing immersive experience for users through one or a plurality of devices. According to an embodiment, the method includes, by at least one computer, providing a framework for centralized communications, providing a companion application gateway (ILACAG) among a centralized set of software modules and remote software modules, providing a framework for serving video content with document overlays and controls applicable to the document overlays, providing a framework for serving video content with Web content overlays and controls applicable to the Web content overlays and providing a framework for serving video content, interactive content, and control signals in an immersive audio-visual system running in Unity and Virtual Reality user device displays.

According to the method, one or a plurality of software applications operating on or through one or a plurality of devices local to a user serve immersive content, where one or plurality of software applications operate within unique operating systems of remote devices.

According to the method, application programming interfaces connect the framework and remote applications supporting multi-path communications among centralized and remote software structures, and a centralized software structure serves content through said framework to remote software structures.

The method, according to an embodiments, allows the devices and respective operating systems to be arranged in parent-child or parent-children's relationships such that any one of the devices and respective operating systems represents the parent and another represents a child or children, the parent serving to control the system and the child or children being controlled by the parent.

Additional aspects will be set forth in part in the description which follows and, in part, will be apparent from the description, or may be learned by practice of the presented embodiments of the disclosure.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram illustrating components and data flow relationships to each other according to an embodiment.

FIG. 2 is a diagram illustrating components from a functional perspective according to an embodiment.

FIG. 3 is a diagram illustrating process flow between a trainer and a trainee using the system according to an embodiment.

FIG. 4 is a diagram illustrating the relationships between various user interfaces, application logic, and the system database according to an embodiment.

FIG. 5 is a diagram illustrating accessible views of functional areas within the system from the perspective of a user interface according to an embodiment.

FIG. 6 is a diagram illustrating GraphQL data query services on the system database, and related process management functions according to an embodiment.

### DETAILED DESCRIPTION

Herein below, various embodiments of the disclosure are described with reference to drawings. Reference is made in detail to embodiments, examples of which are illustrated in the accompanying drawings. In this regard, the embodiments may have different forms and should not be construed as being limited to the descriptions set forth herein. In order to further clearly describe features of the embodiments, descriptions of other features that are well known to one of ordinary skill in the art are omitted here.

As described herein, Immersive Learning Application (ILA) is a cloud-based integrated software system providing a rich context for training/learning. The system allows a user to utilize every available technology to be fully immersed in a simulated or artificial environment.

ILA includes a range of software types and hardware integrations, operating across and integrating a range of current-generation computing, display and communications devices, such as desktop and laptop computers, mobile tablets, mobile phones, flat-screen smart TVs, and virtual reality headsets. ILA enables a wide array of interactions between trainer/teachers and trainee, students, students amongst themselves, educational course administrators, and system managers.

According to an embodiment, ILA may comprise the following software component modules including but not limited to a cloud-based core infrastructure, integrating and serving the user-facing modules; an ILA framework, providing integrated displays and interaction systems for complex courseware, including integration of various combinations of interactive computer displays, document overlays, videos and video overlays, all combined with a real-time data streaming engine; and a framework for a companion apps between tvOS, Roku OS, iOS and Android OS; a framework for interactive Web page & web elements (HTML5) overlays on tvOS, Roku OS, iOS and Android OS; a framework for video support with document control and overlays capability on tvOS, Roku OS, iOS and Android OS; and a framework implementation in Unity and Android virtual reality systems.

ILA, according to an embodiment, supports real-time content exchange from any participating second screen to any other primary or secondary screen, across multiple devices. The entire framework may be operated with any one of the said operating systems serving as the primary collaborating subsystem, and any combination of others serving as secondary collaborating subsystems, arranged in a parent-child or parent children relationship.

While ILA includes software modules and component architectures, some characteristics of which may be found individually elsewhere, the synergy of the interactions of these combined components provide enhanced learning efficiencies which may be derived from the system as a whole not found elsewhere.

Immersive Learning Application (ILA) core provides all the infrastructure necessary to build an Interactive Learning App. It implements the key concepts that all the different plugins will need to work with.

According to an embodiment, the ILA may include features including: Courses and activities: A course is a sequence of activities and resources grouped into sections where the courses themselves are organized into a hierarchical set of categories within an ILA Admin site; Users: Users are anyone who uses the ILA system where in order to participate in courses, users need to be enrolled into specific courses with a given role, such as trainees and trainers; Course enrollment: Enrollment gives user the possibility to participate in course as a trainer or trainees.

According to an embodiment, the ILA may include features User functionality: User roles are assigned to users give them a set of capabilities in given context. For example, Teacher, Student and Forum moderator are examples of roles. A user capability in ILA is a description of some particular ILA feature. Capabilities are associated with roles. A context is a “space” in the ILA, such as e.g., a course, resource, or category, etc. A permission is some value that is assigned for a capability for a particular role. For example, allow or prevent.

The ILA may include other facilities and features which allow synergy components, content and functionality across various solutions to provide enhanced learning efficiencies.

According to an embodiment, the moment a user creates an account, a profile is created for that user. The user may fill in initial details for completing the user's profile. The user generally always has the permission to edit the user's own profile anytime in ILA. Enrollments and access control are additional features of ILA Users are generally enrolled into some courses and according to their permission settings and the groups to which they belong, they have limited access in ILA. Activity and course completion are features of ILA. The activity completion system allows activities such as Quizzes, SCORM modules, etc. to be marked complete when specified conditions are met.

Navigation, settings and configuration characteristics are features of ILA. The Navigation block provide easy access to view various sections of the Immersive Learning Application (ILA) site and includes:
Site pages—links to site pages and resources from the front page of Immersive Learning Application (ILA); and
My profile—quick links allowing a user to view their profile, forums posts, blogs and messages as well as manage their private files; and
My courses—lists and links to courses the user is associated with. Click the course's title to view the front page of the course or use the arrows to navigate quickly to a specific section, resource or activity.

Logs and statistics in ILA: According to an embodiment, the statistics graphs and tables show how many hits there have been on various parts of your site during various time frames. They do not show how many distinct users there have been. They are processed daily at a time you specify. Statistics must be enabled in order for them to be visible. Logs in ILA are activity reports. Logs are available at site level and course level.

ILA is a platform supporting a learning process where the student is immersed in a multi-faceted learning environment comprising a combination of natural, simulated, and artificial environmental elements. ILA supports progressive environments guiding the learning experience through a sequence of increasingly complex or challenging situations, enhancing learning rates and facilitating information retention through memorable contexts.

ILA is designed to be highly extensible and customizable to incorporate multiple devices. The core libraries are structured in a way to accommodate the platform needs.

ILA comprises but is not limited to: the code executing in a Apps (iOS, Android, Smart TV etc.); a database managed by PostgreSQL, and the assets like documents, images, etc., stored for uploaded and generated files (the data folder i.e., in any cloud or same server).

ILA's modular code is separately into layers of functionality, using so-called plug-in modules. These layers operate through Application Programming Interfaces (APIs), providing a secure and comprehensive architecture such that one module can call another from inside the system, or from outside through web-services (such as from a mobile app or through so-called AJAX (asynchronous JavaScript and XML) functionality).

The layers of functionality expressed in terms of their access APIs, according to an embodiment, are as follows:
Low Level API: In this model, the DB tables are accessed through a low-level API that knows about all the types, relationships and validation rules for the data in the tables. No permission checking is done at this level for performance and complexity reasons.
Component API: The component API defines all the things this plugin can do. Every function in the API should perform permission checks and validation on the parameters and return types and be covered by unit tests. This is the useful API that can be used by pages in your plugin, or called directly by another component (only if it depends on this plugin).
External API: The external API is a single class that wraps each function in the Component API. By exposing all the functions in the Component API, we allow administrative users to build new interfaces and apps without requiring changes to any plugin. Each external function is then tested with a unit test ensuring that all our parameters and return types are correctly specified. Note: External API functions can be called directly from other dependent plugins or sub-plugins—but they must use an eternal API call to do so.
Web service API: This is not really an API; it is just a listing of all the functions in the external API in our plugins db/services.php file. This allows all such these functions to be called from AJAX or web services clients like the Mobile App.

According to an embodiment, ILA main facilities may include lessons, resources, questions, languages, lesson management, Live Q&A, VR/Companion App, user roles, permissions, statistics, logs.

In an embodiment, the admin will be able to manage the lessons like create, edit, delete etc., A new lesson contains Lesson type (Video or URL), Thumbnail, Video, Title, Description, App type (VR App or Companion App) and the 360-degree Video. The video and the thumbnails are stored in the cloud and will be accessible from different Apps. The Lesson will be created in multiple ways, either uploading the video or by sharing the external URLs, and using the App type will be able to bifurcate the content to decide the distribution types.

In an embodiment, the admin will be able to manage the resources like create, edit, delete etc., A new resource contains resource material (PDF), Thumbnail, Title, Description. The materials are stored in the cloud and will be accessible from different Apps.

In an embodiment, the admin will be able to manage the questions like create, edit, delete etc., A new question contains a question title, question type like Radio, Checkbox, Free flow text. Based on the question type the user will be able to provide multiple answers.

In an embodiment, the admin may have the provision to manage the multiple languages like create, edit, delete, active/inactive etc.,

In an embodiment, using Lesson Management feature, the admin will be able to allocate the appropriate lessons to the specified languages. There will be multiple lessons associated with each language. And also, there is an ability to choose the respective resource materials for each lesson. So, whenever the end user can refer to the resource materials while learning the lessons.

In an embodiment, the Live Q&A provides very important feature which acts as the bridge between the admin and end users (i.e., teachers and students). The admin will be able to clarify the doubts which are raised by the end users (students). This is real time chat communication which will be notified in all the platforms/devices.

In an embodiment, a VR/Companion App may be provided where the admin may have the permission to distribute all above features in 2 sections i.e., VR App or Companion App.

In an embodiment, User roles may be assigned. For example, when the user is logged into the system, the user will have the “Authenticated user” role in the System context, and since the System context is the root of the hierarchy, that role will apply everywhere. Roles assigned to users give them a set of capabilities in given context. For example: Trainer, Trainee and Organization are examples of roles.

In an embodiment, a permission is some value that is assigned for a capability for a particular role. For example, allow or prevent.

In an embodiment, statistics graphs and tables show how many users logged in to the Apps and usage of their accounts.

In an embodiment, Logs are written in the database, which gives in depth analysis quite easily, and indeed various reports based on the logs are included with them. Even though the log table gets huge, the queries will serve in seconds. The code also includes a custom exception handling mechanism and does not display errors back to the caller, instead logs them in S database. All error messages are read from the standard error file. All the values either come from the database or from the configuration file or from the XML file.

ILA general user functionalities are interpreted in terms of user interface navigation elements used to access areas of functionalities. Any one of six kinds of users can access the system. While six kinds of users such as guests, students, teachers, editing teacher who can modify courses, course creators, and system administrators are discussed, the present application is not limited to any particular kind or type of user. Users access the system from the ILA home page, and either log in or are directed to a signup process, and then log in.

The user is presented with a main menu, comprising the selections of course categories, course settings, resources, activities, account management, and a site map. Each of these menu items is context-sensitive, and may lead to differing further choices depending on the kind of user accessing the system. In general, the choices collectively are as follows.

The course categories menu link leads to a display of course categories. Upon reaching the category, the user is presented with a set of courses as course 1, through course n. Selection of course leads to a set of corresponding lessons, arrayed in sequence as Lesson 1 through Lesson n. Each lesson has associated with it a set of exercises and a quiz. The entire course has an exam.

Course settings are controlled by editing teachers, or course creators, or administrators through the course settings menu. The settings are grouped and managed by topic, lesson frequency, course calendar dates, assignments, types of feedback, and enrollment records. These settings can be viewed (but not modified) by students from the course interfaces.

Resources associated with courses are accessible through the context-sensitive resources menu link and are comprising documentary resources such as books and journals, relevant people including teachers, online participatory resources such as wikis and forums, and other URLs leading to online tools and external support materials.

Activities available through the system are accessible through the context-sensitive menu link, which is viewable in the context of relevant courses. Activities are comprising taking a course, doing an assignment related to a course, taking a course quiz or exam, engaging in a forum discussion, engaging in a chat with other relevant individuals, participating in a course workshop, and engaging in communications between any combination of system users.

Students or other users may view or administer their ILA system accounts or those of others as appropriate, comprising aspects of identification, contact information, courses signed up for, course records, and attendance records.

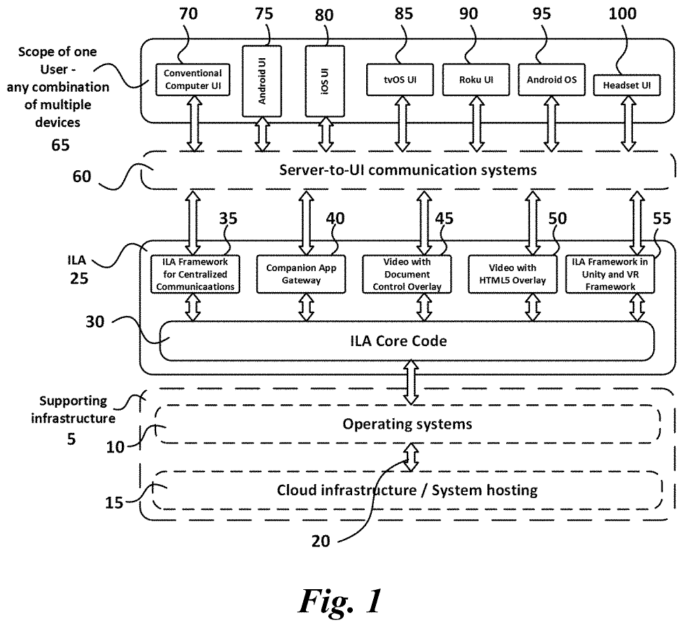

Referring to FIG. 1, ILA is supported in a context of other software which are not parts of which ILA is comprised but are necessary for ILA operating correctly. These components are illustrated in dashed outlines. A Supporting infrastructure 5 is comprised of a so-called cloud hosting environment of servers (cloud infrastructure/system hosting) 15, operating systems 10, and Internet components in communication with each other by means of data flows 20, indicated generically by double arrows throughout FIG. 1. Communications between said servers and remote user devices is through Internet server-to-user-interface communication systems 60.

The software architecture of ILA 25 is comprising a body of core code 30, together with distinct modules providing specific services. The core code 30 in turn operates a framework for centralized communications 35, a communications gateway 40 for companion apps, a module providing the document overlaying video capability 45, a module providing Web content overlaying video capability 50, and a framework supporting displays in virtual reality and so-called mixed reality user device contexts 55.

Each of these modules 35, 40, 45, 50, and 55 are communicating through said server-to-user-interface communication systems 60, to one or any combination of an array of user devices within the scope 65, the array of devices and displays comprising a conventional computer display 70, an Android user interface display 75, an iOS user interface display 80, a tvOS user interface display 85, a Roku user interface display 90, an Android OS user interface display 95, and a virtual reality headset user interface display 100. While specific interfaces and displays are discussed, the present invention is not limited to any particular interface or display. The system allows data from various sources to be obtained to generate aggregated or blended training components that can be accessed, viewed and interacted with using any one or any combination of devices including devices with various types of operating systems and/or interfaces.

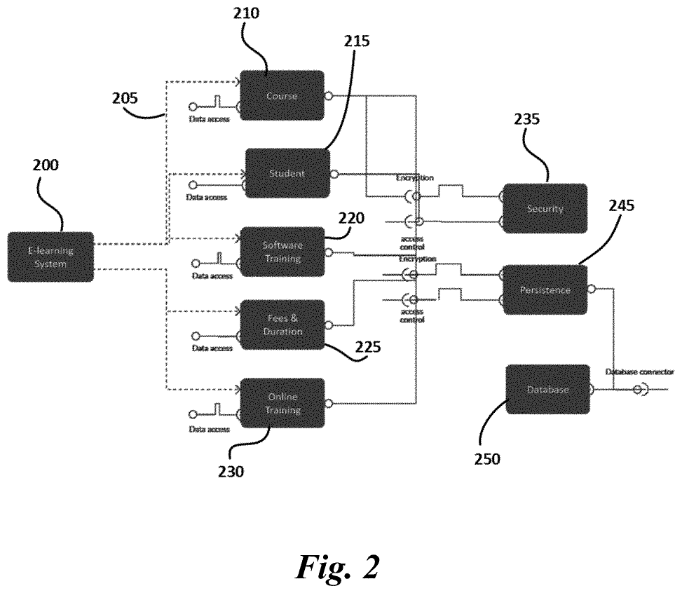

FIG. 2 illustrates the various components wired (communicating/interacting) with each other. The e-learning system 200 is tightly coupled 205 with various data driven components like course 210, students 215, software training 220, fees and duration 225, and online training 230. All these components have provided dependency on the data access as shown in the component diagram. The encrypted data flows in the system in order to have enhanced security 235. Persistence 245 has the required dependency for the access control and encryption as shown in the diagram. The database 250 has the required usage dependency from the database connector.

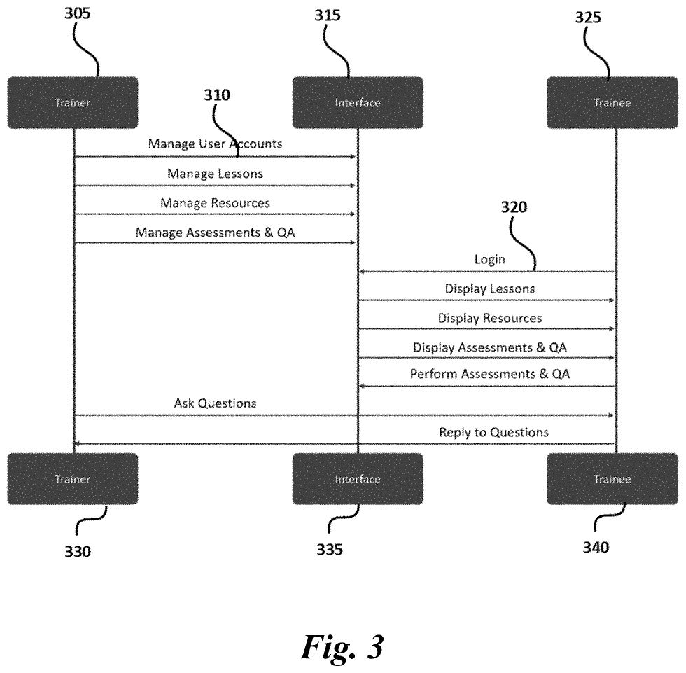

FIG. 3 illustrates the sequence diagram depicting the interaction between the objects in the platform. According to an embodiment, the platform contains 3 major objects i.e., Trainer 305 and 330, Interface 315, and 335 and Trainee 325 and 340 performing various events. The trainer will be able to manage their user accounts by providing the profile details. The trainer will be able to manage the lessons which they are teaching to the trainee. The trainers will be able to manage the resources like images, videos, etc. used for the lessons. The trainers will also be able to manage the assessments and QA which needs to be given to the trainees. The trainee will be able to login to the system. They will be able to see the various lessons provided by the trainer. The trainee will be able to see the resources provided by the trainer. They will also be able to view and take the assessments and QA.

The trainer and trainee will also be able to chat by asking the questions and replying to the questions.

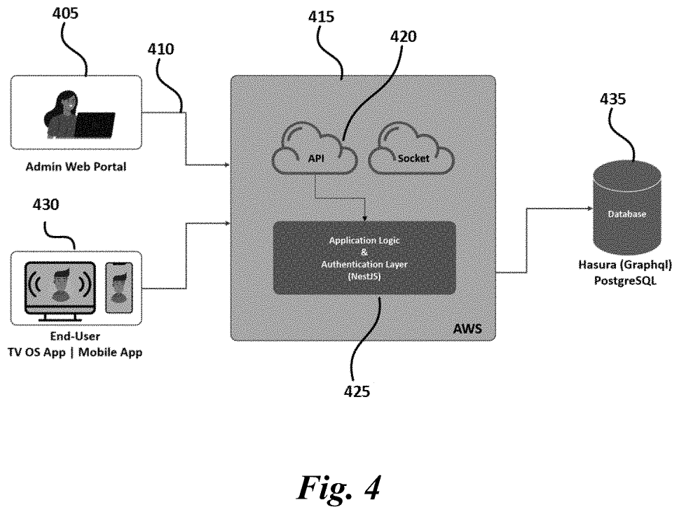

As illustrated in FIG. 4, there are be 2 major types of roles in the system, i.e., Admin 405 and users 430 (trainee and trainer). The admin will be using the web platform while Users will be using the TV OS app or Mobile app. Both the users will be connecting to a cloud server 425 which is present in the AWS (Amazon web services) 415. The application logic and authentication layer is hosted on AWS server and written in reliable NodeJS framework—NestJS. Users will be able to interact with the system using APIs 420. The interaction and syncing between various systems may be done through Realtime sockets. The data will be saved in a database such as the PostgreSQL database 435 by using GraphQL powered engine called Hasura.

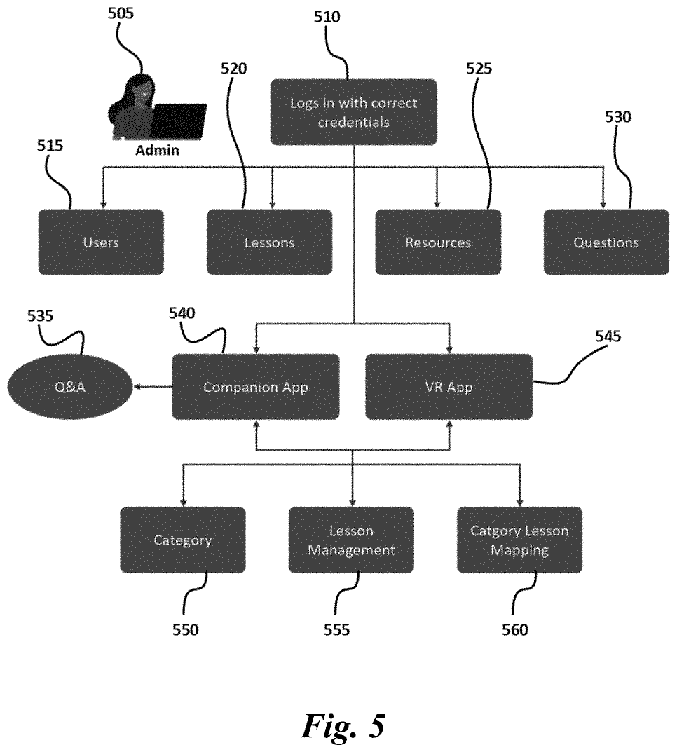

FIG. 5 illustrates the flow for the admin portal. The admin 505 will have to login to the system 510 with correct credentials. They will be able to view the complete list of the users (trainers and trainees) 515 and able to manage them. The admin will also be able to manage all the lessons 520 in the system. The Admin will be able to manage the resources 525 used by the trainers in the system. They will also be able to manage the questions 530 provided by the trainer. The admin will be able to use companion app 540 for Q&A 535. The admin will be able to access and manage the categories 550, lessons 555 and mapping 560 of both through companion app 540 and VR app 545 in the platform.

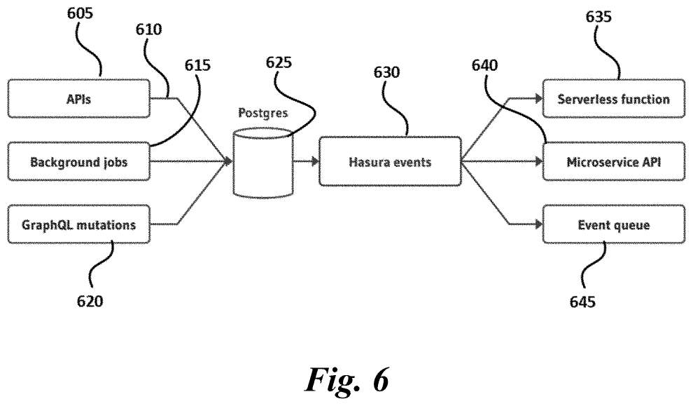

FIG. 6 illustrates the APIs 605, and GraphQL mutations helping data to store in the PostgreSQL, with a plurality of data flows are depicted as arrows 610. Background jobs 615 are created using Hasura events 630, such as schedule functions or schedulers operating on the system database 625. Said functions operate through APIs 605 with multiple hooks to other serverless functions 635, microservices through other APIs 640 and an event queue 645. Receive real time database change updates are received in real-time, as the GraphQL services navigate to different microservices.

ILA Subsystems: An ILA subsystem, according to an embodiment, is a framework combining second-screen, social TV, and training applications with a real-time streaming software engine. ILA includes the use of interactive video hotspots which when triggered, can lead the student through sequential scenarios.

In greater detail: ILA includes a mobile Immersive Learning App (ILA App) framework for Companion App (ILAFCA), which manages communications with remotely held companion apps in memory of one or more mobile computing devices. A companion app communicates with an integrated tracker app to provide extended capabilities, including Internet connectivity, access to online services and other services. ILAFCA coordinates activities between multiple instances of the companion app loaded into memory of mobile computing devices and the integrated tracker app.

Another ILA subsystem provides a framework for a companion app between the ILA server system and user-operated apps on tvOS, Roku OS, iOS, and Android OS devices. This subsystem enables inter-process communication between a plurality of devices connected to the system, including services management means, subscriber/subscription data management means, a call server responsible for jointly managing a control plane layer, and at least one distributed media gateway connected to the central software platform by means of a backbone network. The media gateway is responsible for interconnections between the central platform and an external routing center of a communications network of an associated network operator, which in turn is responsible for routing calls to and from communications terminals connected to that communications network.

Another ILA subsystem supports document display overlay on top of video. The overlays can be transparent, translucent, or opaque, and can be modified on-the-fly to suit the requirements of courseware. While video is playing in the user interface, documents and information contained therein can be combined producing an interactive video display referencing content in the video. A method for preparing courseware using this feature can be used in another module of LTMS (i.e., Studio), developing detailed interactions between document components and identifiable video events.

Another ILA subsystem supports Web page (HTML5 class of Web content) and web elements materials as an overlay viewable on top of video, or video in combination with overlaid documents. ILA includes the means to collect user input by reference from video, from document overlays, from Web page overlays, and all other elements of the immersive environment, and store such information and act on such information in the context of interactive design of courseware running in the ILA environment.

ILAVRF is a software module of ILA which is an immersive audio-visual system (and a method) for creating an enhanced interactive and immersive audio-visual environment is disclosed. The immersive audio-visual environment enables participants to enjoy true interactive, immersive audio-visual reality experience in a variety of applications. The immersive audio-visual system comprises an immersive video system, an immersive audio system, and an immersive audio-visual production system. The video system creates immersive stereoscopic videos that mix live videos, computer-generated graphic images, and human interactions with the system. The immersive audio system creates immersive sounds with each sound resource positioned correctly with respect to the position of an associated participant in a video scene. The immersive audio-video production system produces enhanced immersive audio and videos based on the generated immersive stereoscopic videos and immersive sounds. A variety of applications are enabled by the immersive audio-visual production including casino-type interactive gaming systems and training systems.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method of creating an immersive experience for users through one or a plurality of devices, comprising:
by at least one computer:
providing a framework for centralized communications;
providing a companion application gateway (ILACAG) among a centralized set of software modules and remote software modules;
providing a framework for serving video content with document overlays and controls applicable to the document overlays;
providing a framework for serving video content with Web content overlays and controls applicable to the Web content overlays;
providing a framework for serving video content, interactive content, and control signals in an immersive audio-visual system running in Unity and Virtual Reality user device displays; and
wherein, one or a plurality of software applications operating on or through one or a plurality of devices local to a user serve immersive content, said one or plurality of software applications operating within unique operating systems of remote devices,
wherein application programming interfaces connect said framework and remote applications supporting multi-path communications among centralized and remote software structures, and
wherein a centralized software structure serves content through said framework to remote software structures.

2. The method of claim 1 wherein the devices and respective operating systems are arranged in parent-child or parent-children's relationships such that any one of the devices and respective operating systems represents the parent and another represents a child or children, the parent serving to control the system and the child or children being controlled by the parent.
